(19) United States
(12) Patent Application Publication
(10) Pub. No.: US 2010/0295961 A1
(43) Pub. Date: Nov. 25, 2010

(54) IMAGING APPARATUS AND IMAGE COMPOSITION METHOD

(75) Inventor: Masakazu TERAUCHI, Tochigi (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/782,841

(22) Filed: May 19, 2010

(30) Foreign Application Priority Data
May 20, 2009 (JP) 2009-122260

(51) Int. Cl. H04N 5/228

(52) U.S. Cl. 348/222.1; 348/E05.031

(57) ABSTRACT

An imaging apparatus is provided that includes an image sensor, a composite image processor, a position detector, and a determiner. The image sensor captures an object image through a lens system. The composite image processor merges together a plurality of images captured by the image sensor to produce a composite image. The position detector obtains information related to the position of the apparatus. The determiner evaluates the availability of the composite image. The availability of the composite image is determined with reference to the variation between the position of the apparatus at the beginning of a first exposure and at the beginning of subsequent exposures that are carried out to capture the plurality of images. The positional variation is obtained from this information.

### BACKGROUND OF THE INVENTION

1. Field of the Invention

The present invention relates to an apparatus and method for merging together a plurality of images. In particular, an apparatus and method for merging together images to produce a composite image having a wide dynamic range of luminance may be referred to as high dynamic range imaging (HDRI).

2. Description of the Related Art

Conventionally, a set of high dynamic range imaging techniques is provided that merge together a plurality of photographic images captured under different exposure parameters or values (i.e., under exposure bracketing) in order to generate an image having a wider dynamic range of luminance. Further, in the U.S. Pat. No. 6,952,234, displacement of images by other image frames, which are used in the image composition, is calculated from motion vectors and is used to determine whether or not to carry out the composition.

### SUMMARY OF THE INVENTION

According to the present invention, an imaging apparatus is provided that includes an image sensor, a composite image processor, a position detector and a determiner. The image sensor captures an object image through a lens system. The composite image processor merges together a plurality of images captured by the image sensor to produce a composite image. The position detector obtains information related to the position of the apparatus. And the determiner evaluates the availability of the composite image. The availability of the composite image is determined with reference to the variation between the positions of the apparatus at the beginning of a first exposure and at the beginning of subsequent exposures that are carried out to capture the plurality of images. The positional variation is obtained from this information.

Further, according to the present invention, an image composition method for an imaging apparatus is provided. The method involves sequentially capturing a plurality of images and merging them together to produce a composite image, detecting information related to the position of the imaging apparatus, and determining the availability of the composite image. The availability of the composite image is evaluated on the basis of a variation in the position of the apparatus from the beginning of the first exposure to the beginning of subsequent exposures that are carried out to capture the plurality of images. The positional variation is obtained from this information.

### BRIEF DESCRIPTION OF THE DRAWINGS

The objects and advantages of the present invention will be better understood from the following description, with reference to the accompanying drawings in which:

FIG. 1 is a block diagram schematically illustrating the general structure of an imaging apparatus of the first embodiment of the present invention;

FIG. 2 is a flowchart of an image-capturing operation and the image composition process in the HDR mode of the first embodiment;

FIG. 3 is a flowchart of the image-capturing operation and the image composition process in the HDR mode of the second embodiment;

FIG. 4 is a block diagram schematically illustrating the general structure of an imaging apparatus of the third embodiment of the present invention;

FIG. 5 is a graph indicating the relationship between a positional angle of the imaging apparatus and an angular variation of the third embodiment;

FIG. 6 is a flowchart of the image-capturing operation and the image composition process in the HDR mode of the third embodiment;

FIG. 7 is a graph of the relationship between a positional angle of the imaging apparatus and an angular variation in a prior art anti-shake system applied in a still camera; and

FIG. 13 is a graph of the relationship between a positional angle of the imaging apparatus and an angular variation in a prior art anti-shake system applied in a video camera.

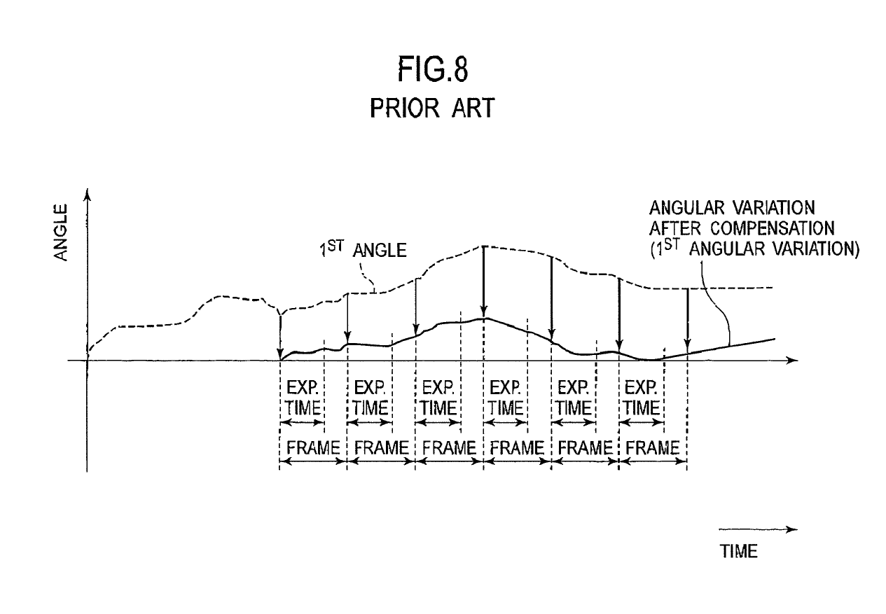

### DESCRIPTION OF THE PREFERRED EMBODIMENTS

The present invention is described below with reference to the embodiments shown in the drawings.

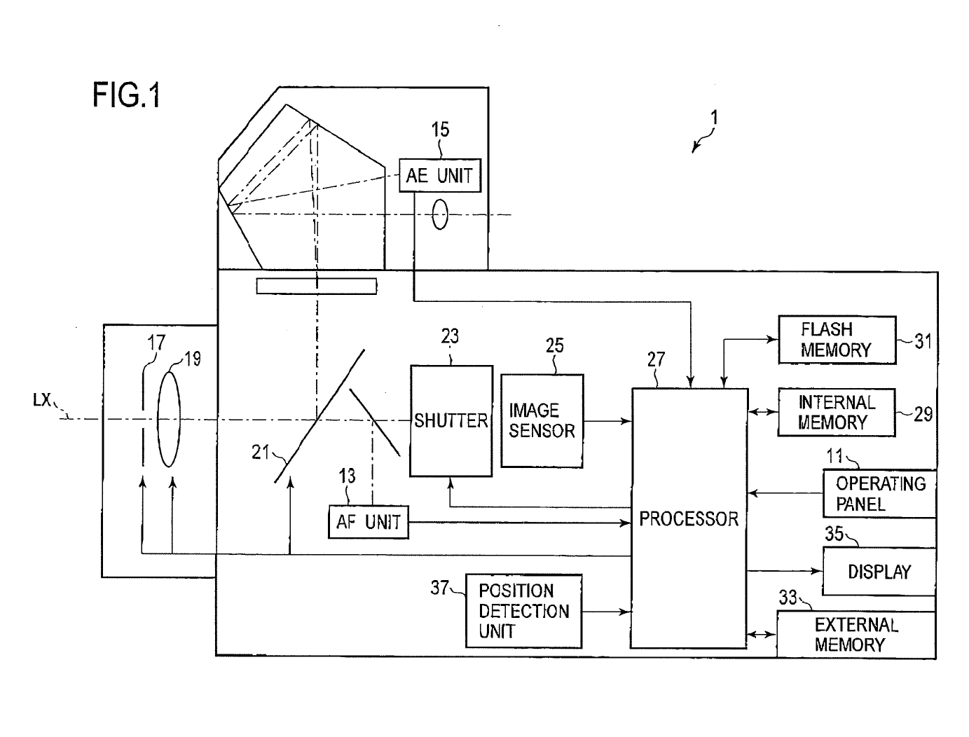

FIG. 1 is a block diagram schematically illustrating the general structure of an imaging apparatus 1 of a first embodiment of the present invention. The imaging apparatus 1 may be a digital camera having a operating panel 11, an AF (autofocus) unit 13, an AE (auto exposure) unit 15, an aperture stop 17, a lens 19, a mirror 21, a shutter 23, an image-capturing unit 25 including an image sensor such as a CCD or CMOS, a processor 27 such as a DSP and/or CPU, an internal memory 29, a flash memory 31, an external memory 33, a display 35, and a positional detector unit 37.

The operating panel 11 includes a release button and a mode-select key (not depicted). When the release button is half depressed, a photometry switch is activated and the AF unit 13 carries out a distance measurement while the AE unit carries out photometry. The result of the distance measurement may be fed into the processor 27 from the AF unit 13 to carry out a focusing operation. Further, the result of the photometry may be fed into the processor 27 from the AE unit 15 to calculate exposure parameters, such as a shutter speed and an f-number.

When the release button is fully depressed, the release switch is activated so that devices including the image-capturing unit 25 start an image-capturing operation. Namely, in the image-capturing operation the aperture stop 17, the mirror 21, and the shutter 23 are respectively driven with appropriate timing to expose the image sensor 25.

The imaging apparatus 1 includes an HDR (High Dynamic Range) mode and a Normal mode. Either the HDR mode or Normal mode is selected by manipulating the mode-select key. When the HDR mode is selected, a plurality of image-capturing operations is sequentially carried out under different exposure values (exposure bracketing). Hereinafter, this series of image-capturing operations may be referred to as a sequential image-capturing operation. A plurality of images captured by this sequential image-capturing operation is merged together to produce an image having a wide dynamic range. On the other hand, when the Normal mode is selected a single image-capturing operation is carried out.

The processor 27 performs image processing on image signals obtained in the image-capturing operation. The processor 27 may further output either the processed or unprocessed image signals to the external memory 33, which may be detachable from the imaging apparatus 1, to store the corresponding image data in the external memory 33. Moreover, the image signals processed by the processor 27 may be fed into the display 35 so that the corresponding images are displayed on the screen.

When the HDR mode is set, the processor 27 controls each component to carry out the sequential image-capturing operation with each image being captured under different exposure values (exposure bracketing). Image signals obtained from the plurality of image-capturing operations are subjected to the above image processing, and the images obtained in this exposure bracketing are merged together to produce a single composite image. Further, the internal memory 29 may temporarily store data during image processing. Furthermore, the flash memory 31 may store programs that execute operations performed in the imaging apparatus 1, such as the image composition process and the like.

The position detection unit 37 may include angular velocity sensors. For example, the angular velocity sensors detect a yawing angular velocity as a first angular velocity and a pitching angular velocity as a second angular velocity at every predetermined time interval (e.g., every 1 ms). The detected angular velocities are fed into the processor 27 and integrated with respect to time. Namely, a yawing angle (a first angle) and a pitching angle (a second angle), which are the integrals of the yawing and pitching angular velocities, are regularly calculated and updated. The detection and integration of the yawing and pitching angular velocities are conducted from the time when the imaging apparatus 1 is powered on.

In the HDR mode, the yawing angle and the pitching angle at the very beginning of the period of exposure for the first shooting of the sequential image-capturing operation are defined as the origin of a yawing variation (a first angular variation) and a pitching variation (a second angular variation). Namely, the processor 27 temporarily stores the yawing angle and the pitching angle measured at the beginning of the first exposure time into the internal memory 29 as reference values, which will be referred to as initial values in the following description.

In the HDR mode, the processor 27 calculates the yawing and pitching angular variations with respect to the initial values. The above calculations are executed at the beginning of every exposure period for each shooting after the first shooting in the sequential image-capturing operation. Further, the processor 27 compares the absolute value of the angular variations with a first threshold value. When it is determined that either one of the angular variations is greater than the first threshold value, displacement between the images captured in the first shooting and the subsequent shootings can be regarded as substantial. Therefore, in such case a warning message is displayed on the display 35 notifying that the displacement of the images in the bracketing is too high for carrying out the image composition, and the sequential image-capturing operation and the image composition process are canceled.

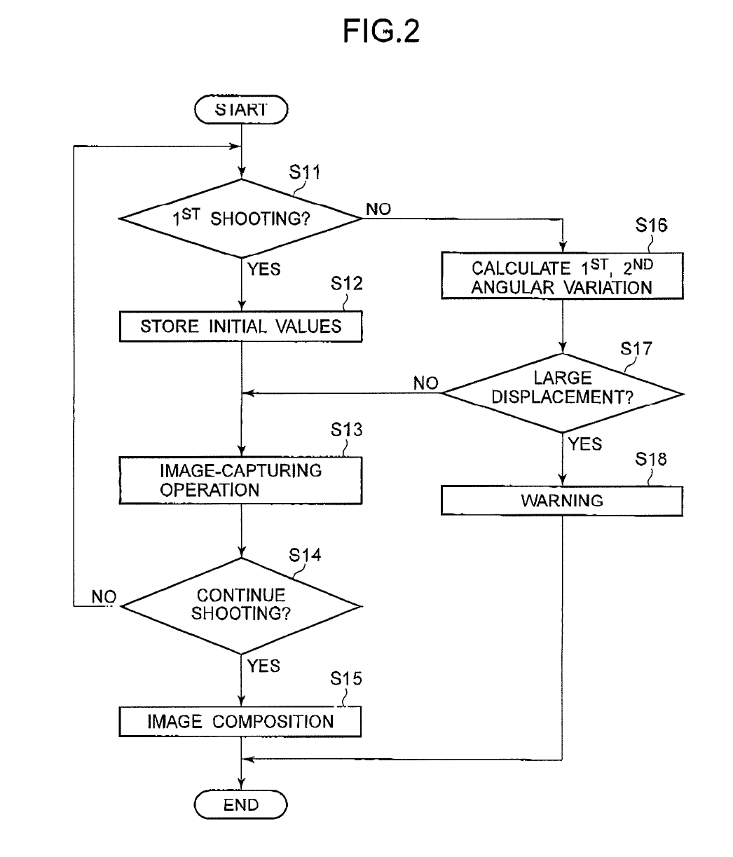

Next the sequential image-capturing operation and the image composition process of the first embodiment, which are executed by the processor 27 in the HDR mode, will be explained with reference to the flowchart in FIG. 2.

When the release button is fully depressed in HDR mode, the process of FIG. 2 begins. In Step S11, whether or not the present image-capturing operation, which will be carried out in this stage, is the first shooting of the sequential image-capturing operation is determined by the processor 27. When the present image-capturing operation is determined to be the first shooting the process proceeds to Step S12, otherwise it skips to Step S16. Note that in the following explanation of the first embodiment, the number of image-capturing operations in the bracketing is only two, as an example, but the number can also be more than two.

In Step S12, at the very beginning of the first exposure, the processor 27 temporarily stores the yawing angle and the pitching angle in the internal memory 29 as the initial values. In Step S13, the processor 27 actuates each component of the imaging apparatus 1 to perform an image-capturing operation. An image captured by the image-capturing operation of Step S13 is temporarily stored in the internal memory 29. In Step S14, the processor 27 determines whether or not the predetermined number of image-capturing operations for the image composition process has been carried out. When it is determined that the predetermined number of image-capturing operation were carried out, the process proceeds to Step S15. Otherwise, the process returns to Step S11 to carry out the next image-capturing operation under different exposure conditions.

In Step S15, the processor 27 merges together the plurality of images that are temporarily stored in the internal memory 29 to generate a single composite image in which the substantial dynamic range is extended. Further, the composite image may be stored in the external memory 33 and may be displayed on the screen of the display 35.

Further, in Step S16, the processor 27 calculates the yawing angular variation (the first angular variation) and the pitching angular variation (the second angular variation) with respect to the initial values that are temporarily stored in the internal memory 29, such that the angular variations calculated at the beginning of the period of exposure for the current image-capturing operation.

In Step S17, the processor 27 compares the absolute value of the current angular variation with the first threshold value. When the current angular variation is determined to be less than or equal to the first threshold value, the displacement between the images captured in the first shooting and the current shooting can be regarded as minute. Therefore, two images can be merged together as a single composite image without substantial displacement and the process proceeds to Step S13. On the other hand, when the current angular variation is determined to be greater than the first threshold value, the process proceeds to Step S18. In Step S18, the warning message is displayed on the display 35 and the sequential image-capturing operation and the image composition process are canceled. The warning message may include information indicating that the position where the current image-capturing operation is being carried out is substantially different from the position where the first image-capturing operation was carried out, and that a composite image obtained from the images captured at these two positions will includes substantial displacement.

Note that the detection of the displacement of images in the HDR mode can also be provided as a mode (a displacement-detecting mode) that is manually selected by a user. In such case, a step that determines whether the displacement-detecting mode is set may be provided prior to Step S17. Namely, when a mode other than the displacement-detecting mode is set, the process proceeds directly to Step S13 and Steps S17 and S18 are disregarded.

In the first embodiment, whether or not a composite image can be obtained with less displacement is determined with respect to the positions of the imaging apparatus 1 that may be represented by the angular variations. In particular, the processor 27 merely compares the (e.g., the first and second angular variations) between the position of the imaging apparatus 1 at the beginning of the first exposure period with the position at the beginning of a succeeding exposure period during the bracketing, and when any of the variance (s) is determined to exceed a certain limit, the sequential image-capturing operation and the image composition process are canceled. Therefore, in comparison to a method using motion vectors extracted from a plurality of images captured in the bracketing, the present embodiment can determine at a relatively early stage whether or not a composite image can be obtained with small displacement.

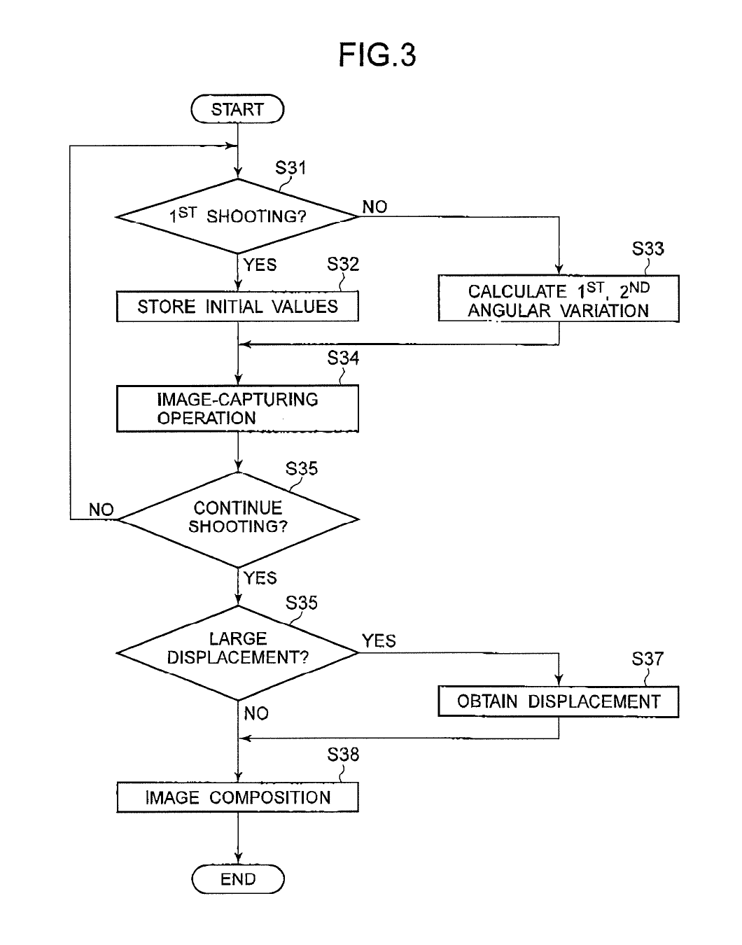

Next a second embodiment of the present invention will be explained in reference to FIG. 3. In the second embodiment, as well as the first embodiment, whether or not a composite image can be obtained with small displacement is determined with respect to the first and second angular variations. However, the second embodiment further carries out an image position adjustment when it is determined that a composite image with small displacement is unavailable. In the following section, matters dissimilar to the first embodiment will be explained mainly.

The physical structure of an imaging apparatus 1 of the second embodiment is the same as that of the first embodiment. The processor 27 determines whether either of the absolute values of the first and second angular variations is greater than the first threshold value. When it is determined that either one of the angular variations is greater than the first threshold value, the displacement between the images captured in the first shooting and the subsequent shootings is regarded as substantial and a composite image with small displacement is unavailable. In such a case, displacement between the images is calculated by comparing the images obtained in either the sequential image-capturing operation or the bracketing, and the plurality of images is merged together after the image position adjustment is carried out.

FIG. 3 is a flowchart of the sequential image-capturing operation and the image composition process of the second embodiment.

Incidentally, the detection and integration of the yawing and pitching angular velocities are conducted from the time when the imaging apparatus 1 is powered on.

When the release button is fully depressed in HDR mode, the process of FIG. 3 begins. Whether or not the present image-capturing operation, which will be carried out in this stage, is the first shooting in the sequential image-capturing operation is determined by the processor 27 in Step S31. When it is determined that the present image-capturing operation is the first shooting, the process proceeds to Step S32, otherwise it continues on to Step S33. Note that in the following explanation of the second embodiment, the number of image-capturing operations in the bracketing is only two, as an example, but the number can also be more than two.

In Step S32, at the very beginning of the first exposure time, the processor 27 temporarily stores the yawing angle and the pitching angle in the internal memory 29 as the initial values.

In Step S33, the processor 27 calculates the yawing angular variation (the first angular variation) and the pitching angular variation (the second angular variation) at the beginning of the period of exposure of the current image-capturing operation with respect to the initial values that are temporarily stored in the internal memory 29. Further, the calculated yawing and pitching angular variations are temporarily stored in the internal memory 29. Namely, the yawing and pitching angular variations (the first and second angular variations) are calculated in each of the image-capturing operations of the bracketing and each of the calculated angular variations is temporarily stored in the internal memory 29.

In Step 934, the processor 27 actuates each component of the imaging apparatus 1 to perform an image-capturing operation. An image captured by the image-capturing operation of Step S34 is temporarily stored in the internal memory 29. In Step S35, the processor 27 determines whether or not the predetermined number of image-capturing operations for the image composition process has been carried out. When it is determined that the predetermined number of image-capturing operations were carried out, the process proceeds to Step S36. Otherwise the process returns to Step S31 to carry out the next image-capturing operation under different exposure conditions.

In Step S36, the processor 27 compares the absolute value of the first and second angular variations, which are temporarily stored for each shooting other than the first shooting, with the first threshold value. When the current angular variation is determined to be less than or equal to the first threshold value, displacement between the images captured in the first shooting and a succeeding shooting can be regarded as minute. Therefore, two images can be merged together as a single composite image without substantial displacement and the process proceeds to Step S38. On the other hand, when one of the angular variations is determined to be greater than the first threshold value, the process proceeds to Step S37.

Note that the detection of displacement of images in the HDR mode can also be a displacement-detection mode that is manually selected by a user. In such case, a step that determines whether the displacement-detection mode is set by the user may be provided prior to Step S36. Namely, when a mode other than the displacement-detection mode is set, the process proceeds directly to Step S38 and disregards Steps S36 and S37.

In Step S37, the processor 27 reads out image data related to the plurality of images temporarily stored in the internal memory 29 and calculates the displacement between the image captured in the first shooting and the images captured in the succeeding shootings. Further, the processor 27 adjusts the positions of the images with respect to the displacement. Note that the displacement may be calculated based on the first and second angular variations. When the displacement is calculated from the first and second angular variations, which are obtained prior to the image-capturing operation of Step S37, the displacement is promptly calculated relative to the case in which it is calculated from the comparison of the images.

Note that when the displacement is unacceptably large for adjusting the position of the images, the processor 27 displays the warning message on the screen of the display and terminates both the sequential image-capturing operation and the image composition process.

Alternatively, the displacement may be calculated from the comparison of the images. In such a case, only a partial area(s) of the images, such as an in-focus area, a face-area, a certain-color area, a certain-brightness area, and the like may be used in the comparison, as well as in the comparison between complete images. Further, the position adjustment process may apply weights to the selected partial area(s).

In Step S38, the processor 27 merges together the plurality of images that are temporarily stored in the internal memory 29 to generate a single composite image in which the substantial dynamic range is extended. Further, the composite image may be stored in the external memory 33 and may be displayed on the screen of the display 35. In particular, in the image composition process of Step S38 carried out after the execution of Step S37, the images are merged together with reference to the calculated displacement between the images after the completion of the image position adjustment to reduce the displacement.

In the second embodiment, whether a composite image with less displacement can be obtained is determined with reference to the positions of the imaging apparatus 1 that may be represented by the angular variations. In particular, the processor 27 merely compares the variation(s) between the positions of the imaging apparatus 1 at the beginning of the first exposure and at the beginning of a succeeding exposure during the bracketing. Further, when the variances are determined to be small, the images are merged together without performing the image position adjustment process. Otherwise, the images are merged together after execution of the image position adjustment process. Therefore, compared to a method using motion vectors extracted from a plurality of images captured in the bracketing, the present embodiment can determine at a relatively early stage whether or not a composite image can be obtained with small displacement.

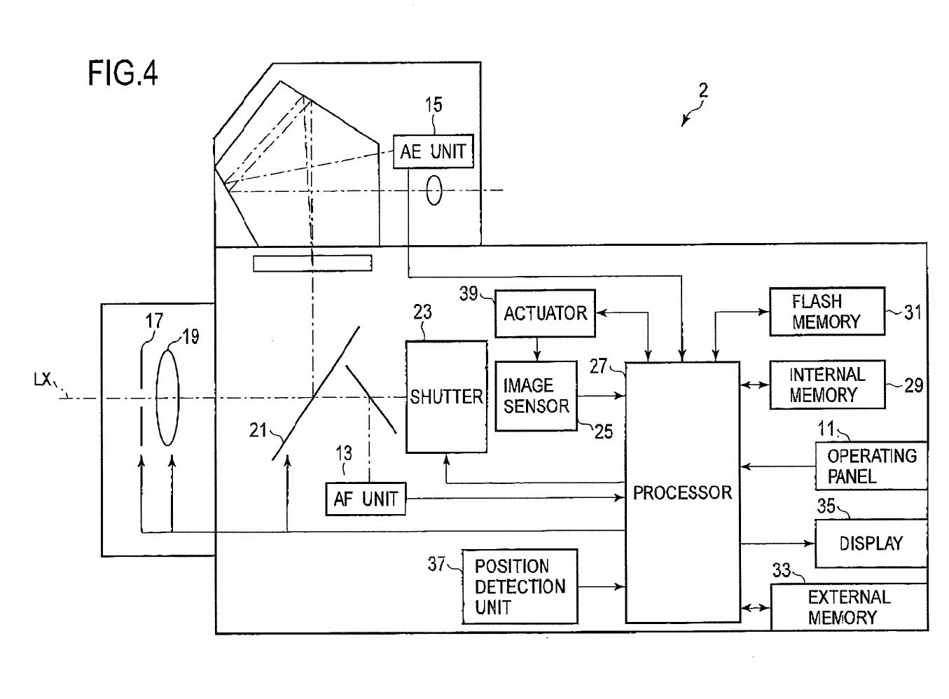

With reference to FIGS. 4-8, a third embodiment of the present invention will be explained. In the third embodiment, by compensating for the position of the image sensor 25 a determination is made with respect to the first and second angular variations as to whether or not images from different frames can be captured without displacement. Namely, whether it is possible to carry out the sequential image-capturing operation while substantially retaining the same relative position of an object image on the imaging surface of the image sensor 25 is determined. When it is determined that it cannot be done, the sequential image-capturing operation and the image composite process are canceled. In the following, matters dissimilar to the first embodiment will be mainly explained.

The imaging apparatus 2 of the third embodiment may be a digital camera, and as shown in FIG. 4, it is provided with an actuator 39 in addition to the components of the imaging apparatus 1 of the first embodiment.

In the third embodiment, when the HDR mode is set a displacement compensation operation is carried out. At the beginning of every exposure in the sequential image-capturing operation, the displacement compensation operation retains the relative position of an object image produced on the imaging surface of the image sensor sc, that the position of the image sensor 25 can be compensated for camera shake.

Namely, in the HDR mode, each component of the imaging apparatus 2 is controlled by the processor 27 to carry out the exposure bracketing. Further, the captured image signals are subjected to image processing and the processed images are merged into a single composite image by the processor 27. In this process, an actuator 39 drives the image sensor 25 with respect to information from the position detector unit 37, which will be detailed later, to compensate for the displacement.

The actuator 39 is controlled by the processor 27 to move the image sensor 25 in a plane perpendicular to the optical axis LX of the lens 19. The actuator 39 may control the movement of the image sensor 37 through PID control by applying electromagnetic force for motive power and using a Hall-effect sensor to detect the position.

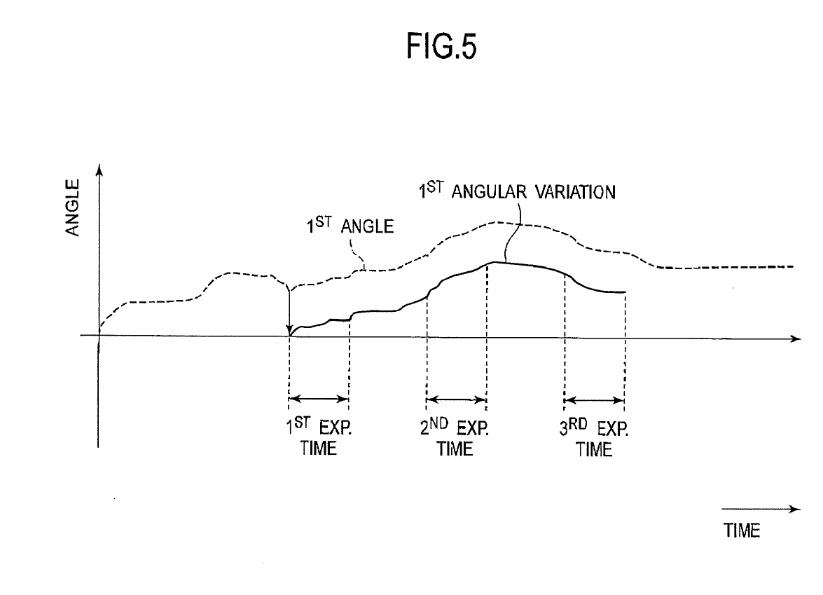

In the HDR mode, the actuator 39 moves the image sensor 25 to the center of the movable area of the image sensor 25 at the beginning of the exposure of the first shooting of the bracketing. At the beginning of the exposure of the succeeding shootings, the image sensor 25 is moved to the position where the displacement (the first and second angular variations) has been compensated. In FIG. 5, time variation of the first angle and the first angular variation are shown with respect to the exposure timing in the bracketing. During the period of exposure, the actuator 39 retains the position of the image sensor 25 in regard to the object image. Thereby, in each frame the displacement of the object image on the imaging surface due to camera shake is eliminated or reduced so that the position of the object image on the image sensor 25 can be maintained in the same position in every frame.

However, when the absolute value of any one of the angular variations at the beginning of a subsequent shooting is greater than the second threshold value (greater than the first threshold value), the object image on the imaging surface cannot be maintained in the same position by moving the image sensor 25. This may correspond to a situation in which the image sensor 25 movement is required to go beyond the predetermined movable area to compensate for the displacement. In such a case, a warning message is displayed on the display 35 notifying that the displacement compensation operation cannot be used and that both the sequential image-capturing operation and image composition process are canceled.

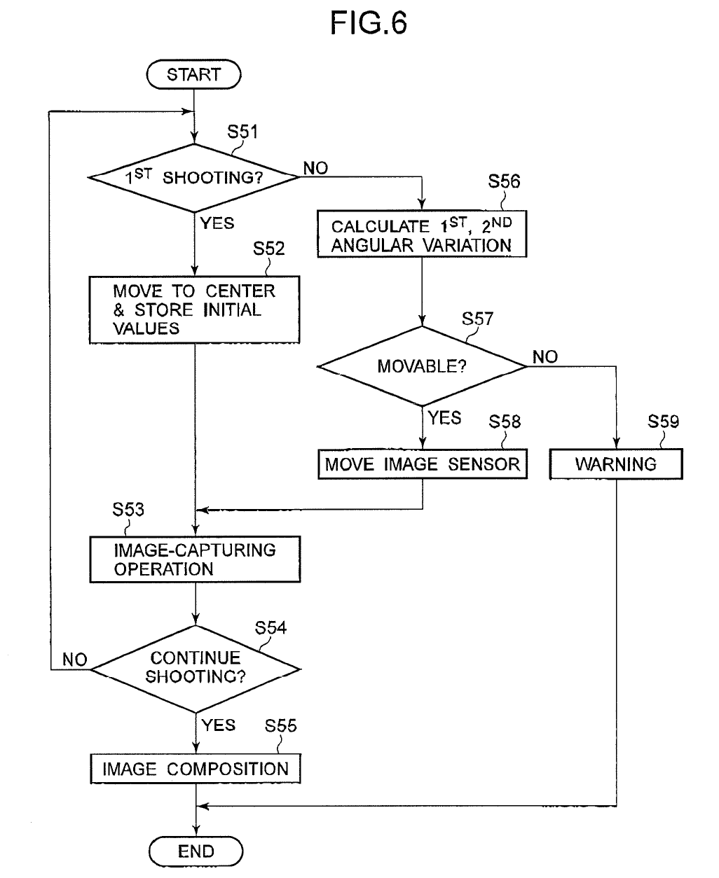

Next a sequential image-capturing operation and an image composition process in the third embodiment will be explained with reference to the flowchart of FIG. 6.

Incidentally, the detection and integration of the yawing and pitching angular velocities are conducted from the time when the imaging apparatus 1 is powered on.

In Step S51, when the release button is fully depressed in HDR mode, the processor 27 determines whether or not the present image-capturing operation, which will be carried out in this stage, is the first shooting in the sequential image-capturing operation. When it is determined that the present image-capturing operation is the first shooting, the process continues on to Step S52, otherwise it proceeds directly to Step S56. Note that in the following explanation of the third embodiment, the number of image-capturing operations in the bracketing is only two, as an example, but the number can also be more than two.

In Step S52, the processor 27 drives the actuator 39 to move the image sensor 25 to the center of the movable area of the image sensor 25 and maintain this position until the beginning of exposure for the next image-capturing operation. Further, the yawing angle (the first angle) and the pitching angle (the second angle) at the very beginning of the first exposure period are temporarily stored as the initial values in the internal memory 29.

In Step S53, the processor 27 actuates each component of the imaging apparatus 1 to perform an image-capturing operation. An image captured by the image-capturing operation of Step S53 is temporarily stored in the internal memory 29. In Step S54, the processor 27 determines whether or not the predetermined number of image-capturing operations has been carried out for the image composition process. When it is determined that the predetermined number of image-capturing operations has been curried out, the process proceeds to Step S55. Otherwise, the process returns to Step S51 to carry out the next image-capturing operation under different exposure conditions.

In Step S55, the processor 27 merges together the plurality of images that are temporarily stored in the internal memory 29 to generate a single composite image in which the substantial dynamic range is extended. Further, the composite image may be stored in the external memory 33 and displayed on the screen of the display 35.

In Step S56, the processor 27 calculates the yawing angular variation (the first angular variation) and the pitching angular variation (the second angular variation) from the initial values that are temporarily stored in the internal memory 29 at the beginning of the exposure period for the current image-capturing operation. In Step S57, the processor 27 determines whether the actuator 39 can move the image sensor 25 to a position where the displacement can be compensated with respect to the angular variations. Namely, whether the yawing angular variation (the first angular variation) of the pitching angular variation (the second angular variation) is greater than the second threshold value is determined, such that a determination can be made as to whether the displacement of the image sensor 25, which is evaluated from the first and second angular variations, is within the movable area of the image sensor 25. When the displacement is determined to be within the movable area the process continues on to Step S58, otherwise it proceeds to Step S59.

Note that the detection of the displacement of images in the HDR mode can also be provided as a displacement-detection mode that is manually selected by a user. In such case, a step that determines whether the displacement-detection mode is set by the user may be provided prior to Step S57. Namely, when a mode other than the displacement-detection mode is set, the process proceeds directly to Step S53 and Steps S57-S59 are disregarded.

In Step S58, the processor 27 controls the actuator 39 to shift the image sensor 25 to the position where the displacement can be compensated, with reference to the yawing angular variance and the pitching angular variance. Further, the image sensor 25 is maintained in this position until the beginning of the exposure period for the next image-capturing operation.

In Step S59, the processor 27 displays a warning message on the display 35 notifying that the displacement compensation operation is unavailable and both the sequential image-capturing operation and the image composition process are canceled.

In the third embodiment, the image sensor 25 is moved with reference to the positions of the imaging apparatus 1 that may be represented by the first and second angular variations, such as the angular variations between the positions of the imaging apparatus 1 at the beginning of the first exposure period and at the beginning of a succeeding exposure period. Namely, in the third embodiment, the sequential image-capturing operation can substantially maintain the relative same position of an object image on the imaging surface of the image sensor 25 throughout different frames. Therefore, image composition by exposure bracketing without image displacement is obtainable. Thereby, a composite image can be obtained for the entire area in which the captured images have been merged together.

Further, when either of the first or second angular variation prohibit the displacement compensation operation from maintaining the positions of the object image on the imaging surface of the image sensor 25, such an when the variation at the beginning of the exposure period of any succeeding image-capturing operation is greater than the second threshold value, both the sequential image-capturing operation and the image composition process are canceled. Therefore, in comparison to a method using motion vectors extracted from a plurality of images captured in the bracketing, the present embodiment can determine at a relatively early stage whether or not a composite image with small displacement is obtainable.

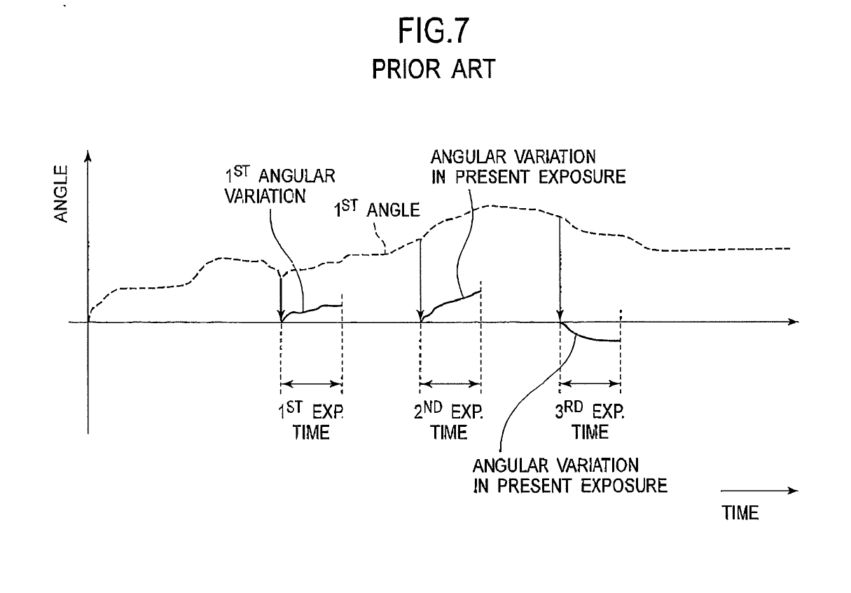

Note that in a prior art with an anti-shake system applied to a still camera, the image sensor or the lens is initially positioned at the center of the movable area for each of the image-capturing operations before the displacement compensation process is actuated. In this configuration, the displacement of the image can be compensated during each exposure period, but the positions of the object image on the imaging surface of the image sensor 25 cannot be maintained in the same position across different frames, i.e., among images captured in the bracketing, see FIG. 7.

Further, in a prior art with an anti-shake system applied to a video camera, the image sensor (or the movable lens) is moved to the center of the movable area at the beginning of the first exposure period, and thereafter the image sensor (or the movable lens) is moved to maintain small angular variations with respect to the initial values. However, in this system, the movement of the image sensor (or the movable lens) is not controlled to maintain the angular variations at zero, since the movement is modified in consideration of a large blur caused by panning, which cannot be compensated for by the anti-shake system. Therefore, this system does not maintain the same position of the object image on the imaging surface across different frames, see FIG. 8.

Note that in the present embodiments, the yawing and pitching angles as used as examples of the first and second angles detected by the position detector unit 37, but the rolling angle may also be detected as a third angle. In this case. The displacement may be compensated for with reference to the first to third angular variations by further rotating the image sensor 25 about the optical axis LX of the lens 19.

Namely, the processor 27 stores the yawing angle (the first angle), the pitching angle (the second angle), and the rolling angle (the third angle) at the very beginning of the first exposure period as the initial values in the internal memory 29. The processor 27 further calculates the angular variations of the first to third angles from the initial values at the beginning of each succeeding exposure period during the bracketing. With respect to the first to third angular variations, the processor 27 determines whether the actuator 39 is capable of moving the image sensor 25 to compensate for the displacement.

When the above determination is affirmative, the processor 27 drives the actuator 39 to move the image sensor 25 (including rotation) with respect to the first to third angular variations to the position that compensates for the displacement. Further, the position of the image sensor 25 is maintained until the beginning of the exposure period for the next shooting. When the above determination is negative, the processor 27 displays a warning message on the screen of the display 35 notifying that the displacement compensation operation is unavailable and both the sequential image-capturing operation and the image composition process are canceled.

The third angular variation may be obtained by using either an angular velocity sensor or an acceleration sensor in a predetermined direction.

Although in the third embodiment, the displacement compensation operation is achieved by moving the image sensor 25, the displacement may also be compensated for by moving a lens(es) in the photographic lens system (represented by the lens 19) in a plane perpendicular to the optical axis LX. However, in this case, the rolling displacement cannot be compensated for.

Further, in the third embodiment, the position of the image sensor 25 is controlled at the beginning of each exposure period of the subsequent image-capturing operations to maintain the same position of an object image on the imaging surface across different frames. However, the image sensor 25 may also be moved to compensate for the displacement generated throughout the period of exposure by calculating the angular variations at predetermined intervals within the exposure period. In such case, motion blur caused by camera shake during the period of exposure can also be compensated for.

The present embodiment is described as the plurality of images captured under different exposure values (in exposure bracketing), however, the images may be captured under the same exposure values. Namely, the present invention can also be applied to any bracketing other than exposure bracketing.

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2009-122260 (filed on May 20, 2009), which is expressly incorporated herein, by reference, in its entirety.

1. An imaging apparatus, comprising:
an image sensor that captures an object image through a lens system;
a composite image processor that merges together a plurality of images captured by said image sensor to produce a composite image;
a position detector that obtains information related to the position of said apparatus; and
a determiner that evaluates the availability of said composite image;
said availability of said composite image being determined with reference to the variation between the position of said apparatus at the beginning of a first exposure and at the beginning of subsequent exposures that are carried out to capture said plurality of images, and said positional variation being obtained from said information.

2. The imaging apparatus as in claim 1, wherein when said positional variation is greater than a threshold value, a position adjustment of said plurality of images is carried out before said composite image processor merges said plurality of images.

3. The imaging apparatus as in claim 2, wherein said position adjustment is carried out with reference to the amount of said positional variation.

4. The imaging apparatus as in claim 1, wherein said composite image processor stops merging said plurality of images when said positional variation is greater than a threshold value.

5. The imaging apparatus as in claim 1, further comprising:
a position controller that moves at least one of said image sensor and a movable lens provided in said lens system, in a plane perpendicular to the optical axis of said lens system;
wherein a relative position of the object image on the imaging surface of said image sensor is retained at the same position by said position controller at least at the beginning of each exposure of said plurality of images, with respect to said positional variation; and
wherein said composite image processor stops merging said plurality of images when an absolute value of said positional variation is greater than a threshold value.

6. The imaging apparatus as in claim 1, wherein said plurality of images is captured in exposure bracketing.

7. The imaging apparatus as in claim 1, wherein said position detector comprises an angular velocity sensor.

8. The imaging apparatus as in claim 7, wherein said positional variation comprises the variation of a yawing angle and the variation a pitching angle of said imaging apparatus.

9. An image composition method for an imaging apparatus, comprising:
capturing a plurality of images in sequence;
merging together a plurality of images to produce a composite image;
detecting information related to the position of said imaging apparatus; and
determining availability of said composite image;
said availability of said composite image being determined with reference to the variation between the position of said apparatus at the beginning of a first exposure and at the beginning of subsequent exposures that are carried out to capture said plurality of images, and said positional variation being obtained from said information.
